(19) United States
(12) Patent Application Publication
(10) Pub. No.: US 2008/0177731 A1
(43) Pub. Date: Jul. 24, 2008

(54) DATA PROCESSING APPARATUS, DATA PROCESSING METHOD AND SEARCH APPARATUS

(75) Inventor: Naoki MATSUZAKI, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JustSystems Corporation, Tokushima-shi (JP)

(21) Appl. No.: 12/018,656

(22) Filed: Jan. 23, 2008

(30) Foreign Application Priority Data
Jan. 23, 2007 (JP) 2007-013161

(51) Int. Cl. G06F 17/30

(52) U.S. Cl. 707/5; 707/E17.046

(57) ABSTRACT

A data processing technique is provided with improved convenience.

A data processing apparatus includes: a concept tree setting unit 22 which sets a concept tree that indicates the user's purposes or intentions; a classification unit 24 which, based upon the concept tree, classifies a data set created by or acquired by the user; a book display unit 26 which displays the data set thus classified; a search request unit 28 which makes a request for a search using the concept tree or the data set classified based upon the concept tree as a query; and a search result acquisition unit 32 which acquires, as a result of the search, the data set classified based upon the concept tree.

### BACKGROUND OF THE INVENTION

1. Field of the Invention

The present invention relates to a data processing technique, and particularly to a data processing apparatus, a data processing method, and a search apparatus for processing data based upon conceptual information that reflects the user's purposes, intentions, etc.

2. Description of the Related Art

Use of the Internet has established an environment in which users can acquire diverse kinds of data. Furthermore, personal computers with improved performance are available, providing the capacity to store a large mass of data, leading to a massive flood of electronic data in the user's environment.

### DISCLOSURE OF THE INVENTION

### Problem to be Solved by the Invention

The utility value of using a large mass of data is low if the data has been randomly stored. Accordingly, there is a demand for a data processing technique for processing data with improved convenience for the user giving consideration to what the user values.

### SUMMARY OF THE INVENTION

The present invention has been made in view of such a situation. Accordingly, it is a general purpose of the present invention to provide a data processing technique with improved convenience for the user.

### MEANS TO SOLVE THE PROBLEM

An embodiment of the present invention relates to a data processing apparatus. The data processing apparatus comprises: a concept information setting unit which sets concept information that indicates a user's purposes or intentions; a storage unit which stores a data set created or acquired by the user; a classification unit which classifies the data set based upon the concept information; and a display unit which displays the data set thus classified.

Also, the concept information setting unit may set, as the concept information, a hierarchical tree by classifying multiple keywords that indicate the user's purposes or intentions. Also, the classification unit may calculate a degree of similarity between each item of data included in the data set and the keywords. The data that exhibits a higher degree of similarity with a given keyword than a predetermined value may be classified under a node that corresponds to the given keyword, thereby classifying the data set in a hierarchical manner.

Also, the data processing apparatus may further comprise an acquisition unit which acquires from a different apparatus a data set classified based upon concept information. With such an arrangement, the classification unit may classify the data set thus acquired by the acquisition unit based upon the concept information set by the concept information setting unit.

Also, the data processing apparatus may further comprise an update unit in which, when the update unit detects that the data set acquired by the acquisition unit has been updated by the different apparatus, the update unit instructs the acquisition unit to acquire the data set thus updated by the different apparatus. With such an arrangement, the classification unit may classify the updated data set based upon the concept information.

Also, the data processing apparatus may further comprise an acquisition unit which acquires the concept information from a different apparatus. With such an arrangement, the classification unit may classify the data set stored in the storage unit based upon the concept information acquired by the acquisition unit.

Also, the data processing apparatus may further comprise an update unit in which, when the update unit detects that the concept information acquired by the acquisition unit has been updated by the different apparatus, the update unit instructs the acquisition unit to acquire the concept information thus updated by the different apparatus. With such an arrangement, the classification unit may classify the data set stored in the storage unit based upon the concept information thus updated.

Also, the data processing apparatus may further comprise a search request unit which makes a request for a search for the concept information or the data set using the keywords, the concept information, or the data set as a query; and a search result acquisition unit which acquires the concept information or the data set as a result of the search.

Another embodiment of the present invention relates to a data processing method. The data processing method is a method for instructing a computer to execute processing. The processing comprises: setting a hierarchical tree by classifying multiple keywords that indicate a user's purposes or intentions; calculating a degree of similarity between each item of data included in a data set created by or acquired by the user and the keywords, and classifying the data that exhibits a higher degree of similarity with respect to a given keyword than a predetermined value under a node that corresponds to the given keyword, thereby classifying the data set in a hierarchical manner; and displaying the data set thus classified.

Yet another embodiment of the present invention relates to a search apparatus. The search apparatus comprises: a search request reception unit which receives a search request with concept information, including a hierarchical tree created by classifying multiple keywords that represent a user's purposes or intentions, as a query; a creation unit which searches for data based upon each keyword included in the concept information, and which classifies the data that exhibits a higher degree of similarity with respect to a given keyword than a predetermined value under a node that corresponds to the given keyword, thereby creating a data set classified in a hierarchical manner based upon the concept information; and a search result transmission unit which transmits the data set thus created as the search results.

Yet another embodiment of the present invention also relates to a search apparatus. The search apparatus comprises: a search request reception unit which receives a search request with concept information, including a hierarchical tree created by classifying keywords that represent a user's purposes or intentions, a data set classified in a hierarchical manner based upon the concept information, or the keywords, as a query; a search unit which searches for concept information or data sets analogous to the concept information, the data set, or the keywords thus received; and a search result transmission unit which transmits the concept information or the data set thus extracted as the search results.

It should be noted that any combination of the aforementioned components or any manifestation of the present invention realized by modification of a method, apparatus, system, and so forth, is effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows an example of a concept tree and a book;

FIG. 2 is a diagram which shows a configuration of a data processing system according to an embodiment;

FIG. 3 is a diagram which shows a configuration of a terminal according to the embodiment;

FIG. 4 is a diagram which shows a configuration of a search server;

FIG. 5 is a flowchart which shows a procedure for a data processing method according to the embodiment;

FIG. 6 is a flowchart which shows another data processing method according to the embodiment;

FIG. 7 is a diagram which shows an example of a user interface via which the data is classified by means of a classification unit;

FIG. 8 is a diagram which shows another example of the user interface via which the data is classified by means of the classification unit;

FIG. 9 is a sequence diagram which shows another procedure for the data processing method according to the embodiment;

FIG. 10 is a sequence diagram which shows yet another procedure for the data processing method according to the embodiment;

FIG. 11 is a sequence diagram which shows yet another procedure for the data processing method according to the embodiment;

FIG. 12 is a sequence diagram which shows yet another procedure for the data processing method according to the embodiment;

FIG. 13 is a sequence diagram which shows yet another procedure for the data processing method according to the embodiment;

FIG. 14 is a diagram which shows an example of a screen displayed by a book display unit;

FIG. 15 is a diagram which shows another example of the screen displayed by the book display unit;

FIG. 16 is a diagram which shows yet another example of the screen displayed by the book display unit;

FIG. 17 is a diagram which shows an example of a search screen displayed by a search request unit;

FIG. 18 is a diagram which shows yet another example of the screen displayed by the book display unit;

FIG. 19 is a diagram which shows an example of a screen for displaying the search results made by a search server with respect to the book;

FIG. 20 is a diagram which shows an example of a screen for displaying the search results made by a search server with respect to the concept tree; and

FIG. 21 is a diagram which shows an example of a screen updated by an update unit.

### DETAILED DESCRIPTION OF THE INVENTION

The invention will now be described by reference to the preferred embodiments. This does not intend to limit the scope of the present invention, but to exemplify the invention.

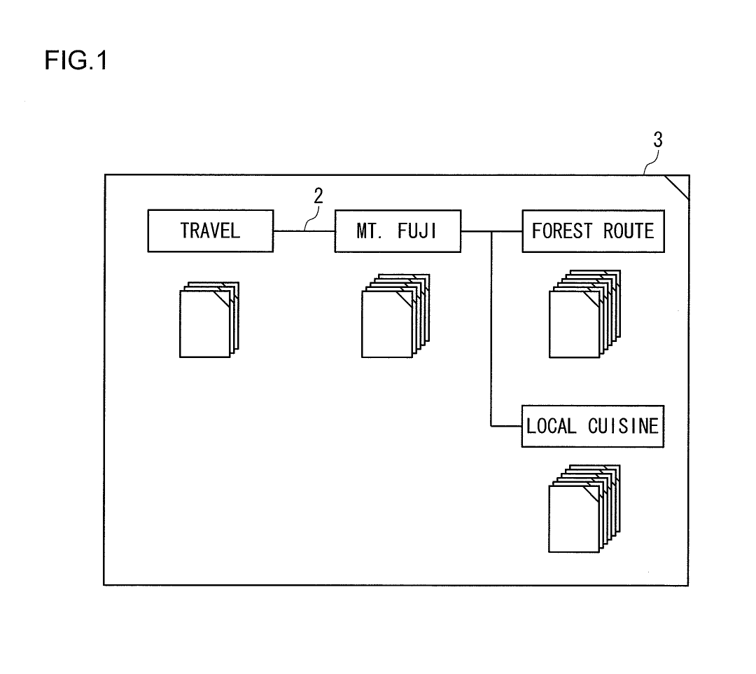

When the user collects data for certain purposes, the data set reflects the user's purposes, intentions, and what the user values. For example, FIG. 1 shows a data set collected for a trip to Mt. Fuji. The user collected information with respect to the forest routes around Mt. Fuji using a search service via the Internet before going for a drive to Mt. Fuji along a forest route. Furthermore, the user collected information with respect to the local cuisine in the area around Mt. Fuji. Such a data set can provide information that reflects the user's purposes and intentions, such as to enjoy a relaxed trip while enjoying the local cuisine etc.

However, if the same user makes a new plan for a trip to the Tohoku region after making the plan for the trip to Mt. Fuji, with conventional search services, the user needs to set a keyword again so as to collect the information with respect to the forest route therearound and the local cuisine in this area. With the present embodiment, a technique is proposed which collects and classifies data using the information included in the user's own data set which indicates the user's purposes and intentions. The structured conceptual information 2 which indicates the user's purposes and intentions will be referred to as a “concept tree” hereafter. The data set 3 classified according to the concept tree will be referred to as a “book”. In the concept tree, keywords may be employed as the nodes forming the concept tree. Also, with respect to the book, the corresponding data set may be associated with each keyword in the concept tree.

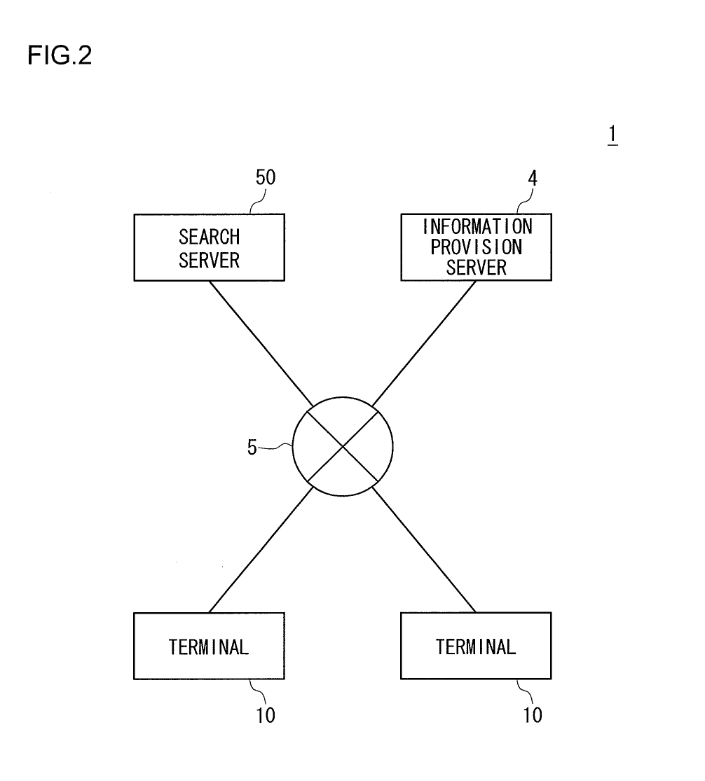

FIG. 2 shows a configuration of a data processing system according to an embodiment. In a data processing system 1, a user terminal 10, an information provision server 4 which provides information to the terminal 10, and a search server 50 which searches the information provided by the information provision server 4 or the like for the user's desired information according to a search request made via the terminal 10, are connected to each other via the Internet 5. The terminal 10 collects the information from the information provision server 4 according to the concept tree which indicates what the user values, classifies the information thus collected in the form of a book, and stores the information. Upon reception of a search request from the terminal 10 for a search with respect to the concept tree or the book, the search server 50 executes search processing.

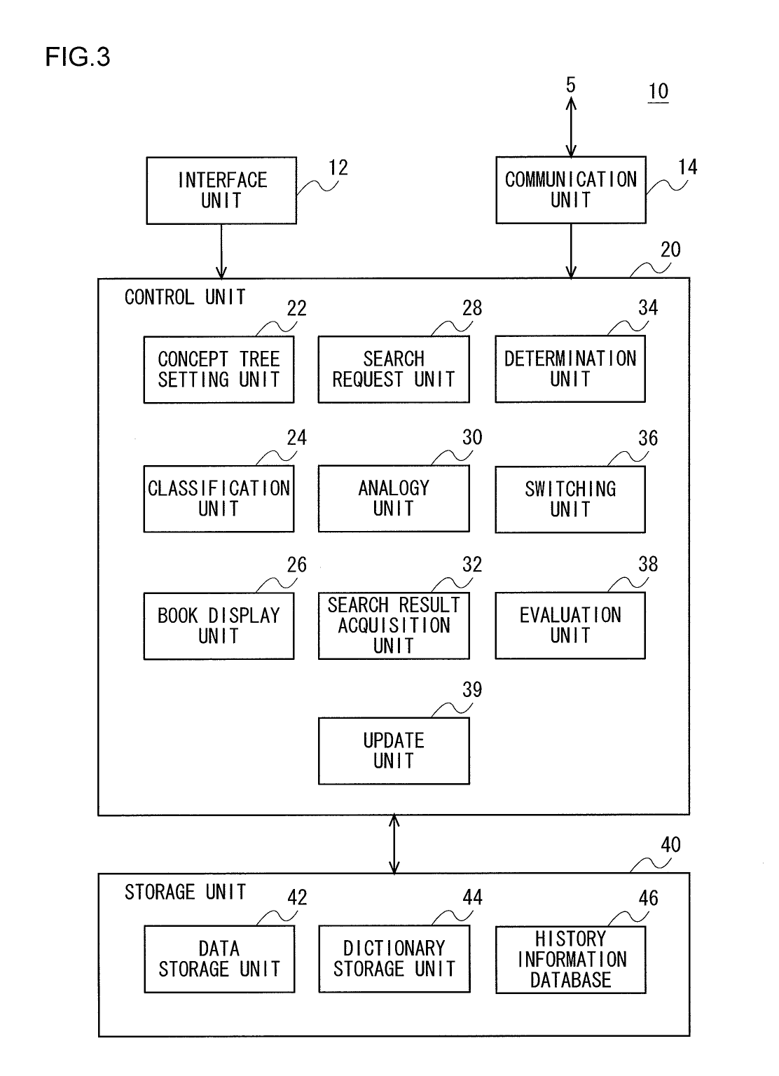

FIG. 3 shows a configuration of the terminal according to the embodiment. The terminal 10 is an example of a data processing apparatus, which includes an interface unit 12, a communication unit 14, a control unit 20, and a storage device 40. The control unit 20 includes a concept tree setting unit 22, a classification unit 24, a book display unit 26, a search request unit 28, an analogy unit 30, a search result acquisition unit 32, a determination unit 34, a switching unit 36, an evaluation unit 38, and an update unit 39. The storage device 40 includes a data storage unit 42, a dictionary storage unit 44, and a history information database 46. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it would be understood by those skilled in the art that these function blocks can be realized in a variety of forms by hardware only, software only or the combination thereof.

The concept tree setting unit 22 sets a concept tree which indicates the user's purposes, intentions, what the user values, etc. The concept tree may be set before the user creates a book. Also, the concept tree may be set during a step for creating a book in order to classify the data included in the book. Upon reception of multiple keywords from the user which reflect the conceptual information with respect to the user's objects, intentions, interests, etc., the concept tree setting unit 22 classifies these keywords in a hierarchical structure, thereby creating a concept tree. Also, such multiple keywords may be classified in a non-hierarchical structure. In this case, it can be said that the concept tree has a tree structure that has only one hierarchical class.

The concept tree setting unit 22 may automatically set the concept tree by analyzing the data set collected by the user. For example, an arrangement may be made in which characteristic terms are extracted from among freestanding words such as nouns, verbs, etc., by performing morphological analysis on the text data included in a data file stored in the data storage unit 42 of the storage device 40, thereby acquiring keywords that reflect the content of the data file. Such an arrangement allows common keywords to be extracted across multiple data files, thereby creating a concept tree.

The classification unit 24 classifies the data created by or acquired by the user, according to the concept tree set by the concept tree setting unit 22. The classification unit 24 may receive from the user the correspondence between the data and keywords so as to classify the data. Also, the classification unit 24 may calculate the degree of similarity between the data and the keywords by analyzing the content of the data, and may classify the data set in a hierarchical manner by classifying the data which exhibits a higher degree of similarity with a keyword than a predetermined value under the node that corresponds to the keyword. Also, in the step for calculating the degree of similarity between a keyword and the data, a keyword set for the upstream nodes of the target node may be inherited by the target node. With such an arrangement, the data may be classified giving consideration to the degree of similarity between these keywords thus inherited and the data. Also, the data may be classified giving consideration to the degree of similarity between the data and the keywords set for sibling nodes or descendant nodes. For example, in a step for calculating the degree of similarity between a certain keyword and data, if there is a high degree of similarity between the data and the keyword set for the ancestor nodes, the sibling nodes, or the descendant nodes, the degree of similarity between the data and the keyword set for the current node may be raised. On the other hand, if there is a low degree of similarity between the data and the keyword set for an ancestor node, a sibling node, or a descendant node, the degree of similarity between the data and the keyword set for the current node may be reduced. Such an arrangement allows the data to be classified giving consideration to the user's purposes and intentions defined by the overall concept represented by the concept tree.

As described above, the data created or acquired by the user is classified by the classification unit 24 according to the concept tree. The data thus classified is stored in the data storage unit 42 of the storage device 40. The data storage unit 42 may store the data in directories having the same hierarchal structure as that of the concept tree. Also, the data may be stored independently of the concept tree. Thus, such an arrangement creates a book according to what the user values such as the user's purposes, intentions, interests, etc.

With such an arrangement in which the data storage unit 42 stores the data in the form of a directory tree having the same structure as that of the concept tree, the concept tree can be represented by a directory tree provided by the data storage unit 42. The concept tree may be represented using an XML file that indicates the data storage locations in a hierarchical manner. With such an arrangement, the data may be stored in the data storage unit 42 without involving the hierarchical structure of the concept tree. With such an arrangement in which the data storage locations are represented using an XML file, the data may be stored without involving the directory tree even if the concept tree is represented by a directory tree provided by the data storage unit 42. The book may be statically defined, or it may be dynamically created as needed. With the latter arrangement, the classification unit 24 classifies the data stored in the data storage unit 42 so as to create a book every time the book is displayed or searched. The classification unit 24 may refer to the data stored in the information provision server 4 for the data for the content of the book.

The book display unit 26 displays the data included in the book according to the concept tree. For example, an arrangement may be made which displays a concept tree and a list of data files associated with respective keywords. With such an arrangement, when the user selects a desired data file, the content of the data file may be displayed. Such an arrangement allows a set of data to be classified and displayed according to what the user values.

When a data set is acquired from other devices via the communication unit 14, the book display unit 26 may display the data set thus acquired according to the user's own concept tree stored in the user's own apparatus. For example, the classification unit 24 may newly classify the data set included in a different user's book according to the user's own concept tree stored in the user's own apparatus, and the book display unit 26 may display the data set thus classified like the user's own book stored in the user's own apparatus. In a case in which multiple concept trees are available, such an arrangement may allow the user to select a desired concept tree to be applied. Also, such an arrangement may allow the concept tree which is to be applied to be switched between the user's own concept tree and other concept trees acquired from other apparatuses. Such an arrangement allows the user to classify and display data sets acquired by or created by other users according to what the user values, thereby improving the convenience for the user. Furthermore, such an arrangement allows other concept trees to be applied, thereby classifying and displaying data sets according to various kinds of values that differ from what the user values. Such an arrangement helps the user to analyze a data set from a new viewpoint.

For example, such an arrangement allows the user to classify and listen to music data stored by a different user according to a genre list of the user's own playlist categories. Also, such an arrangement allows the user to classify the articles that appear in a different user's blog into the categories employed in the user's own blog, and allows the user to browse the articles thus classified. Furthermore, such an arrangement allows the contributions to bulletin boards, news sites, etc., to be automatically classified into the categories set by the user himself/herself, and allows the user to browse the articles thus classified. If the server that provides blogs, articles, etc., has an API which allows the content to be divided and which allows the content to be provided in increments of parts thus divided, such an arrangement allows the content described in a single web page to be classified into different categories, and allows the user to browse the content thus classified. Furthermore, such an arrangement allows bookmarked URLs, phone numbers, etc., to be classified according to what the user values, and allows the user to refer to the information thus classified.

The search request unit 28 makes a request to the search server 50 for a search using the keywords, the concept tree, or the book as a query. As described later, the search server 50 has a function of making a search based upon the keywords included in the concept tree received as a query so as to create a book. Also, the search server 50 has a function of searching for a concept tree or a book analogous to the keywords, the concept tree, or the book received as a query. The search result acquisition unit 32 acquires a concept tree, book, etc., from the search server 50 as the search results.

When the search request unit 28 makes a request for a search using a concept tree as a query, the analogy unit 30 predicts the user's purposes, intentions, interests, and what the user values based upon the keywords included in the concept tree, in order to expand the keywords. The analogy unit 30 extracts the synonyms, quasi-synonyms, broad terms, and narrower terms derived from the keywords included in the concept tree with reference to an analogy dictionary stored in the dictionary storage unit 44, and adds these terms thus extracted to the search keywords to be transmitted by the search request unit 28 as a query. For example, in a case in which the concept tree includes the keyword “out-of-the-way”, the analogy unit 30 may add a synonym “countryside” to the search keywords with reference to the analogy dictionary. Also, an arrangement may be made in which the analogy unit 30 acquires the meaning of the term “out-of-the-way” with reference to a Japanese-language dictionary, searches the Japanese-language dictionary for terms that are analogous to the meaning of the search term, and adds the analogous terms thus acquired to the search keywords. With such an arrangement, the analogy unit 30 may extract terms analogous to the meaning “out-of-the-way and thinly populated areas”, examples of which include “little-known places”, “quiet”, etc.

The determination unit 34 determines the display priority for the data set included in the book acquired as the search results. The determination unit 34 prioritizes the data with reference to the history information database 46. For example, in a case in which the history information database 46 stores the history of the user's operations of referring to data with respect to “local cuisine” in the book as shown in FIG. 1, the determination unit 34 may display the data with respect to “local cuisine” at the first priority level.

The switching unit 36 replaces a part of or all of the data, the display of which had been determined to be at the first priority level, with different data. For example, in the book shown in FIG. 1, the data to be displayed is switched from the data with respect to “local cuisine” to the data with respect to “forest routes”.

The evaluation unit 38 modifies the history information stored in the history information database 46 according to the user's operations or the like. When the switching unit 36 switches the data to be displayed, the evaluation unit 38 may register with the history information database 46 the information with respect to the data to be displayed at the first priority level. In this case, the evaluation unit 38 may evaluate the change in what the user values. For example, if the keyword “forest routes” in the concept tree is switched to the keyword “expressways”, the evaluation unit 38 may evaluate that what the user values has changed, from giving priority to beautiful scenery along the way to the destination, to giving priority to saving time, and may store this evaluation of what the user values in the history information database 46.

In order to classify the data set by means of the classification unit 24 according to the concept tree, the evaluation unit 38 may adjust a weighting factor used for calculating the degree of similarity between the keyword set for the concept tree and the data according to the change in what the user values. For example, if the keyword is changed from “forest routes” to “expressways”, the evaluation unit 38 may apply a positive weighing factor to the keyword “expressways” as a keyword used for evaluating whether or not the data is to be classified under the node “local cuisine”. In this case, the information with respect to restaurants that provide local cuisine, which is to be provided at the first level, is switched from information with respect to restaurants along the forest routes to information with respect to restaurants located in expressway service areas. Such an arrangement creates a book that reflects what the user values at an improved level.

When the weighting factor is changed, the evaluation unit 38 may reevaluate the classification of the data which has already been classified. The evaluation unit 38 may recalculate the degree of similarity between the data which has already been classified and the keywords set for the concept tree so as to reclassify the data set. With such an arrangement, the data that exhibits a lower degree of similarity than a predetermined level may be eliminated from the book. In this case, the search request unit 28 may instruct the search server 50 to search for data to be substituted for the data thus eliminated from the book, and the data thus extracted may be added to the book. Also, if the quantity of data classified into a given keyword is smaller than a predetermined value, the search server 50 may newly search for data, and the data thus extracted may be added to the data set.

If the update unit 39 detects that a concept tree or a book acquired from a different apparatus has been updated according to an instruction from the different apparatus, the update unit 39 acquires the concept tree or the book thus updated from the different apparatus. The update unit 39 may receive a notice from the apparatus which has acquired the concept tree or book to the effect that the concept tree or the book has been updated. Also, the update unit 39 may inquire at a predetermined timing whether or not the concept tree or the book has been updated. If the update unit 39 detects that the concept tree or the book has been updated, the update unit 39 may display the concept tree or the book thus updated in an easily distinguishable fashion. If the update unit 39 detects that the concept tree or the book has been updated, the update unit 39 may operate according to the update. Also, such an arrangement allows the user to select whether or not the update unit 39 should operate according to the update. The update unit 39 may store, according to an instruction from the user, the concept tree or the book which was acquired before the update. Also, the update unit 39 may store the concept tree or the book which was acquired after the update. Also, the update unit 39 may store a log of the concept tree or the book so as to allow the user to restore a previous state, i.e., to switch from the state after the update to the state before the update.

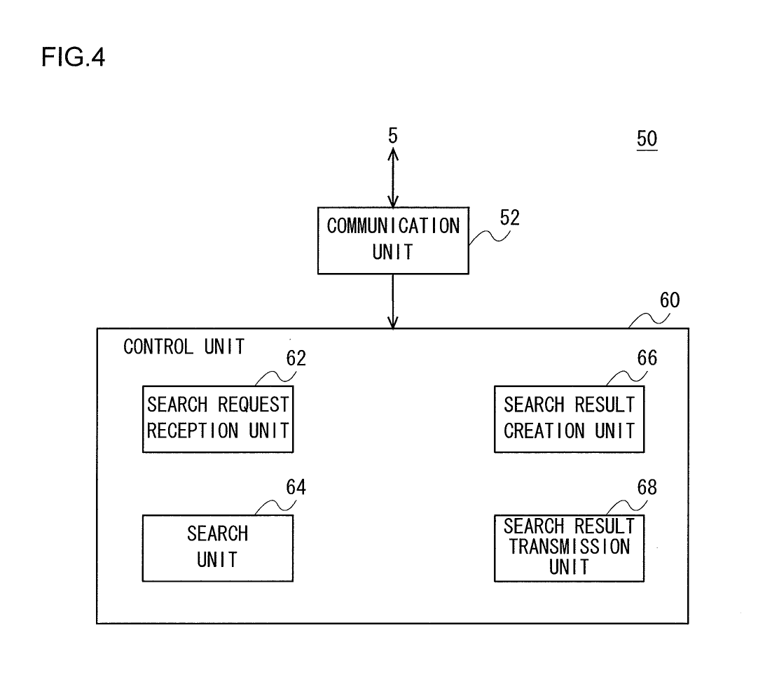

FIG. 4 shows a configuration of the search server 50. The search server 50 includes a communication unit 52 and a control unit 60. The control unit 60 includes a search request reception unit 62, a search unit 64, a search result creation unit 66, and a search result transmission unit 68. Also, these function blocks can be realized in a variety of forms by hardware only, software only or the combination thereof.

The search request reception unit 62 receives a keyword, a concept tree, or a book, from the terminal 10 in the form of a query. The search unit 64 searches the content made available via the information provision server 4 etc., based upon the keyword, the concept tree, or the book received by the search request reception unit 62. The search result creation unit 66 creates the search result to be transmitted to the terminal 10 based upon the search result obtained by the search unit 64. The search result transmission unit 68 transmits the search result thus created to the terminal 10.

If the search unit 64 receives a keyword as a query, the search unit 64 searches the concept trees stored in the information provision server 4, the search server 50, etc., for a concept tree including keywords that are analogous to the keyword thus received. The search result creation unit 66 selects the concept tree that exhibits a high degree of similarity with respect to the keyword as the search result.

If the search unit 64 receives a concept tree as a query, the search unit 64 searches the content using multiple keywords included in the concept tree and the search keywords added by the analogy unit 30 as a query. The search result creation unit 66 extracts the content that exhibits high scores in increments of keywords, and creates a book according to the concept tree. In this case, the score may be determined with reference to other keywords included in the concept tree or the hierarchical structure of the concept tree. Also, an arrangement may be made in which, when the search request reception unit 62 receives a book as a query, a search is made in the same way as it is when the concept tree applied to the book is received as a query.

If the search unit 64 receives a book as a query, the search unit 64 may search the books made available via the information provision server 4 for a book that is analogous to the book thus received. In this case, the degree of similarity with respect to the book may be determined with reference to the degree of similarity with respect to the keywords set for the concept tree applied to the book, the degree of similarity with respect to the concept tree structure, the degree of similarity between the data sets associated with the respective keywords, etc. The search result creation unit 66 employs as the search result the book that exhibits a high degree of similarity or the concept tree applied to such a book.

If a given concept tree is received as a query, the search unit 64 may search for a concept tree that is analogous to the given concept. Also, in this case, the search unit 64 may search for a book to which the concept tree that is analogous to the given concept tree is applied.

Such a technique allows the user to search an auction or shopping site for items close to what the user values, and allows a suggestion to be made with reference to a purchase history. Also, such a technique allows AV machines to make a suggestion according to what the user values and the user's interests. Also, such a technique allows a map site to display shopping information, destinations, etc., on a map according to what the user values. Also, such a technique allows a book to be shared between a server, cellular phone terminal, car navigation system, etc., so as to search for and display information such as areas, shops, etc., according to what the user values. Such an arrangement allows a car navigation system to set the areas or shops thus extracted to be a destination or the like. Furthermore, such an arrangement allows the user to add items to the book, such as an actual route along which the user has driven, snapshots, etc. Also, such a technique allows a hotel reservation site or the like to extract information based upon information that accords to what the user values, instead of conditions prepared beforehand. Such an arrangement allows additional information such as information with respect to nearby shops etc., to be displayed according what the user values.

The concept tree setting unit 22 allows the user to modify the concept information with respect to the book thus obtained as the search result. Furthermore, the classification unit 24 allows the user to reclassify and select the data included in the book. Moreover, the classification unit 24 allows the user to add new data to the data set so as to edit the book. The book thus edited reflects what the user values. Such an arrangement allows the user to search for a book closer to what the user values.

The concept tree and book are information that reflects what the user values. Accordingly, such information is useful for marketing. For example, obtaining the information in a browsing user's book allows an advertisement provider to display advertisements according to what the user values and the user's interests. Furthermore, such an arrangement allows the researcher to make an evaluation with respect to services, items, etc., to be classified and displayed according to various kinds of values.

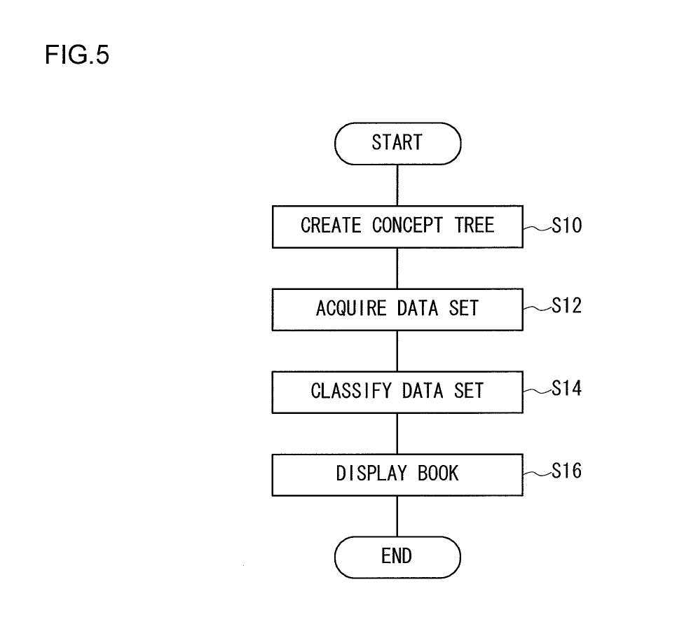

FIG. 5 is a flowchart which shows a procedure for a data processing method according to the present embodiment. FIG. 5 shows a procedure for creating a book by classifying a data set collected by the user according to a concept tree created by the user. First, via a user interface provided by the concept tree setting unit 22, the user designs a hierarchical structure according to which the data set is to be classified. The nodes of the hierarchical structure are represented by respective keywords, thereby creating a concept tree (S10). Subsequently, the user collects a data set using the information provision server 4, the search server 50, etc (S12). Then, the classification unit 24 classifies the data set based upon the degree of similarity between the data thus collected and the keyword set for each node of the concept tree, thereby creating a book (S14). The book display unit 26 displays the book thus created (S16).

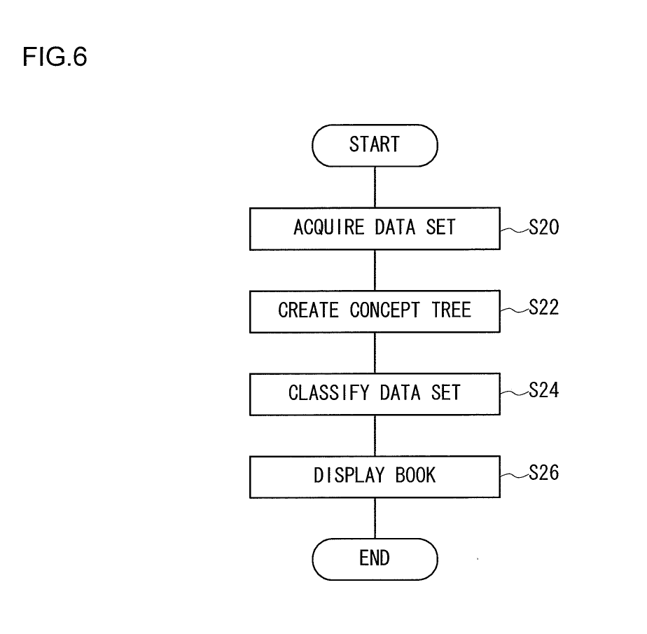

FIG. 6 is a flowchart which shows another procedure for the data processing method according to the present embodiment. FIG. 6 shows a procedure performed by the terminal 10 for creating a book by automatically classifying a data set collected by the user. First, the user collects a data set using the information provision server 4, the search server 50, etc (S20). Then, the concept tree setting unit 22 creates a concept tree by automatically analyzing the data set thus collected (S22). The classification unit 24 classifies the data set based upon the degree of similarity between the data thus collected and the keyword set for each node of the concept tree, thereby creating a book (S24). The book display unit 26 displays the book thus created (S26).

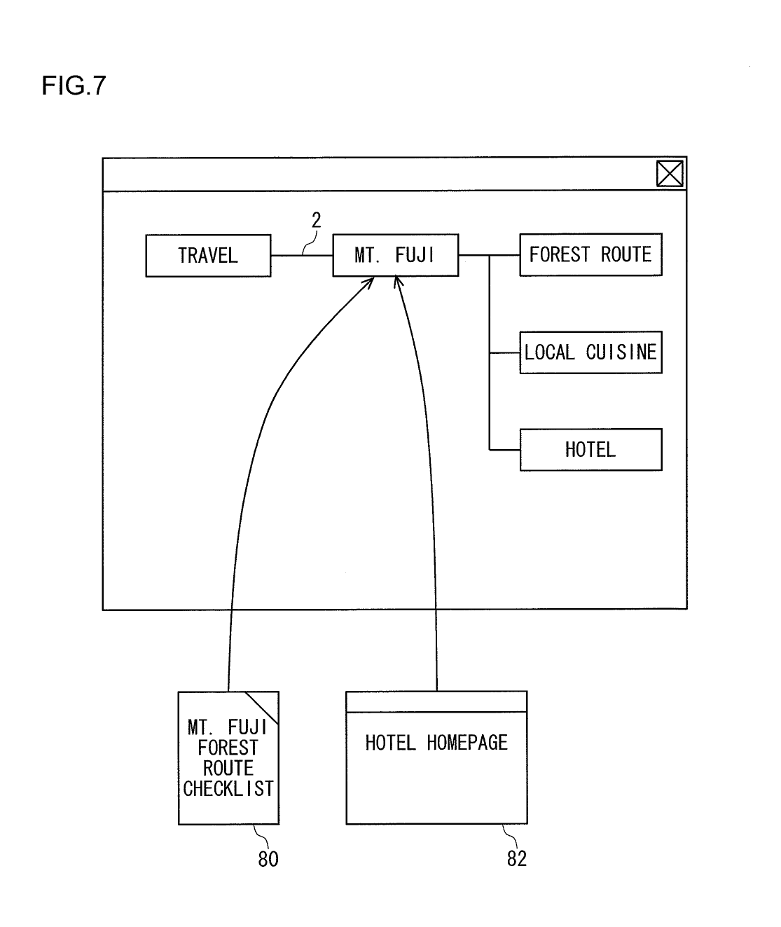

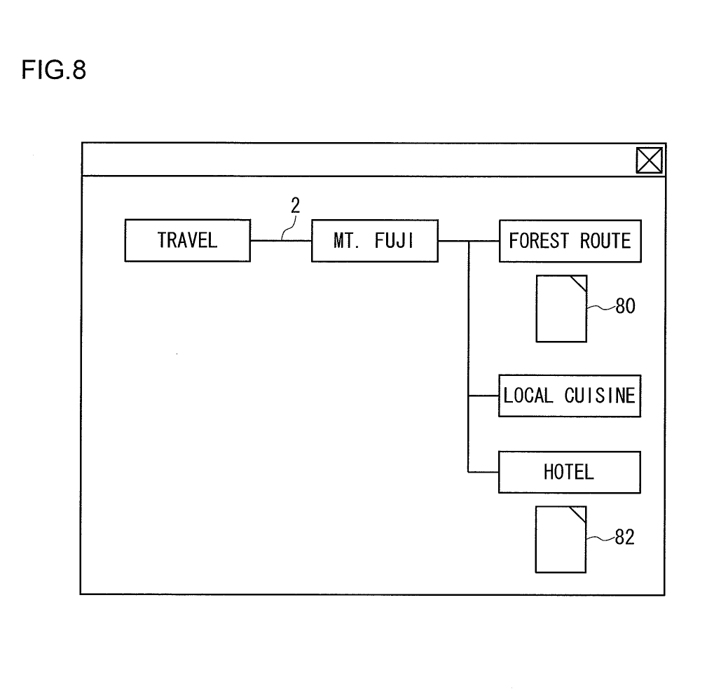

FIG. 7 shows an example of the user interface provided by an arrangement in which the classification unit 24 classifies the data. Such an arrangement allows the user to classify desired data under a desired node, or under a downstream node thereof, by performing a drag and drop operation. For example, when the user drags and drops a “Mt. Fuji forest route checklist” document 80 on the “Mt. Fuji” node, the classification unit 24 calculates the degree of similarity between the keywords set for the “Mt. Fuji” node and the keywords set for the downstream nodes thereof and the characteristic terms included in the “Mt. Fuji forest route checklist” document 80, and classifies the document 80 under a node that exhibits a high degree of similarity. Also, when the user drags and drops a “hotel homepage” window 82 on the “Mt. Fuji” node, the classification unit 24 calculates the degree of similarity between the keywords set for the “Mt. Fuji” node and the keywords set for the downstream nodes thereof and the characteristic terms included in the “hotel homepage”, and classifies the hotel homepage 82 under a node that exhibits a high degree of similarity. In this case, as shown in FIG. 8, the “Mt. Fuji forest route checklist” 80 is classified under the “forest routes” node, and the hotel homepage 82 is classified under the “hotels” node.

If the user desires to classify the data under a node that differs from the node automatically selected by the classification unit 24, such an arrangement may allow the user to select the node under which the data is to be classified. For example, if the hotel described in the hotel homepage 82 offers local cuisine, when the user drops the “hotel homepage” window 82 on the “local cuisine” node, the classification unit 24 classifies the hotel homepage 82 under the “local cuisine” node. Also, an arrangement may be made which allows the user to move the hotel homepage 82 automatically classified by the classification unit 24 under the “hotels” node to the “local cuisine” node by performing a drag and drop operation. Also, such an arrangement allows a single item of data to be shared among multiple nodes. For example, if the user desires to classify the “Mt. Fuji forest route checklist” document 80 under the “hotels” node in addition to the “Mt. Fuji” node, such an arrangement may allow the user to classify a copy of the document 80, which has been automatically classified under the “forest route” node by the classification unit 24, under the “hotels” node.

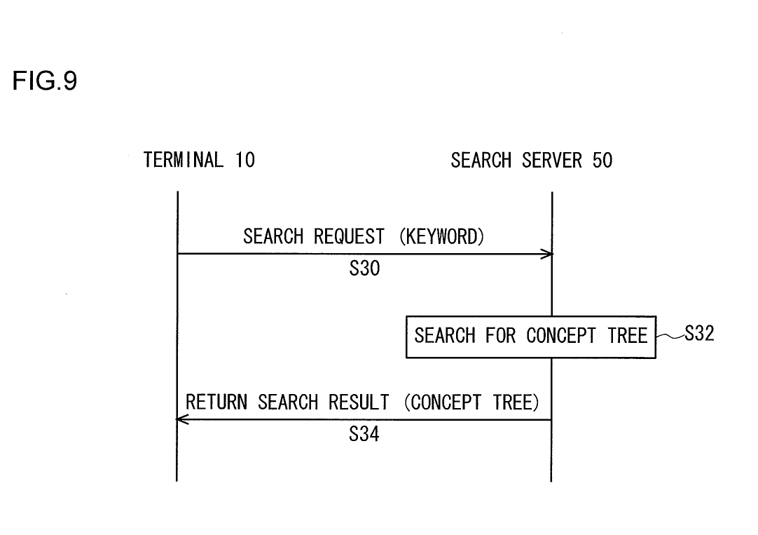

FIG. 9 is a sequence diagram which shows another procedure for the data processing method according to the present embodiment. FIG. 9 shows a procedure performed by the terminal 10 for searching for a concept tree via the search server 50 based upon keywords. First, the search request unit 28 of the terminal 10 transmits multiple keywords to the search server 50, and makes a request to the search server 50 for a search for a concept tree (S30). The search server 50 searches the great number of concept trees that it stores for a concept tree that exhibits a high degree of similarity with respect to the multiple keywords thus received (S32). Then, the search server 50 transmits the concept tree thus extracted to the terminal 10 as the search result (S34). Such an arrangement allows the user to acquire a concept tree that serves as a framework for classifying the data, thereby allowing the user to appropriately classify the user's own data.

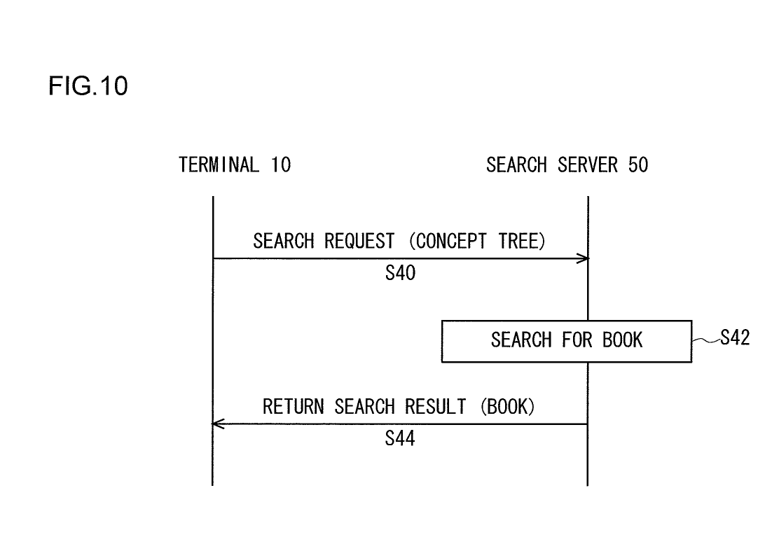

FIG. 10 is a sequence diagram which shows yet another procedure for the data processing method according to the present embodiment. FIG. 10 shows a procedure performed by the terminal 10 for searching for a book via the search server 50 based upon a concept tree. First, the search request unit 28 of the terminal 10 transmits the concept tree set by the concept tree setting unit 22 to the search server 50, and makes a request for a search for a book (S40). The search server 50 searches the great number of books that it stores for a book structured according to the similar concept tree as the concept tree thus received (S42). Then, the search server 50 notifies the terminal 10 of the book thus extracted as the search result (S44). Thus, such an arrangement allows the user to design a concept tree having a desired data framework, and allows the user to acquire data for which the framework matches the framework thus designed by making a search request.

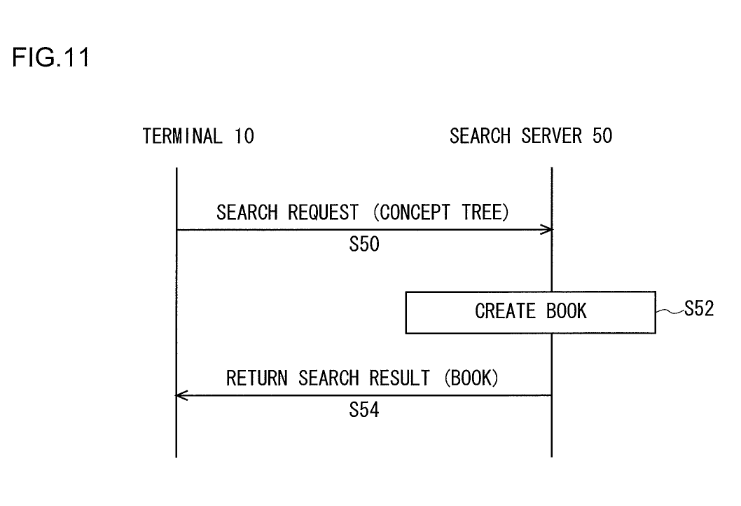

FIG. 11 is a sequence diagram which shows yet another procedure for the data processing method according to the present embodiment. FIG. 11 shows a procedure performed by the terminal 10 for making a request to the search server 50 to create a book based upon a concept tree. First, the search request unit 28 of the terminal 10 transmits a concept tree set by the concept tree setting unit 22 to the search server 50, and makes a request to create a book (S50). The search result creation unit 66 of the search server 50 collects data by performing a search based upon each of the keywords included in the concept tree, and creates a book by classifying the data thus collected according to the concept tree (S52). Then, the search server 50 transmits the book thus created to the terminal 10 (S54). Such an arrangement allows the user to design a concept tree having a desired data framework, and allows the user to acquire data for which the framework matches the framework thus designed by making a search request.

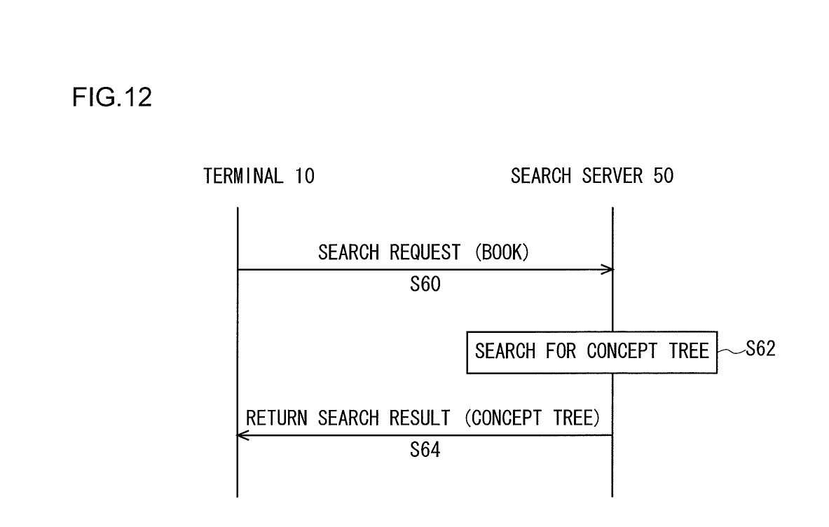

FIG. 12 is a sequence diagram which shows yet another procedure for the data processing method according to the present embodiment. FIG. 12 shows a procedure performed by the terminal 10 for searching for a concept tree via the search server 50 based upon a book. First, the search request unit 28 of the terminal 10 transmits a book stored in the data storage unit 42 to the search server 50, and makes a request for a search for a concept tree (S60). The search server 50 searches for a book that includes data that is analogous to the data included in the book thus received (S62). Then, the search server 50 notifies the terminal 10 of the concept tree of the book thus extracted as the search result (S64). Thus, such an arrangement allows the user to classify according to a different concept tree a book that has already been created.

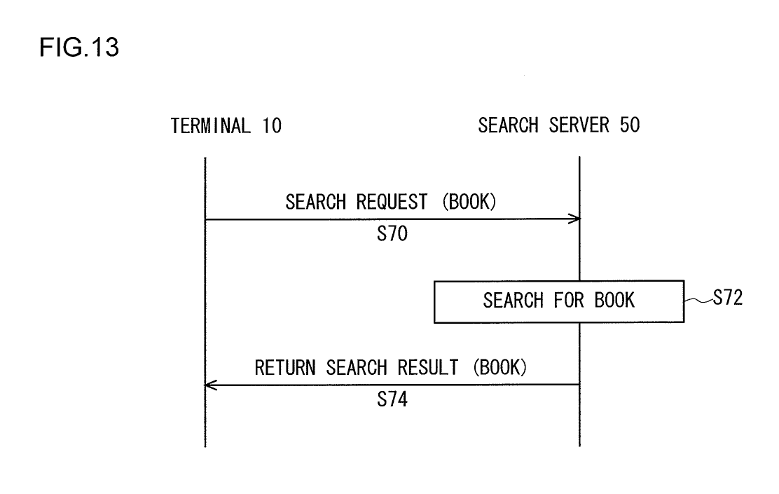

FIG. 13 is a sequence diagram which shows yet another procedure for the data processing method according to the present embodiment. FIG. 13 shows a procedure performed by the terminal 10 for searching for a book via the search server 50 based upon a book. First, the search request unit 28 of the terminal 10 transmits a book stored in the data storage unit 42 to the search server 50, and makes a request for a search for a book (S70). The search server 50 searches for a book classified according to a concept tree that is analogous to the concept tree of the book thus received (S72). Then, the search server 50 notifies the terminal 10 of the book thus extracted as the search result (S74). Thus, such an arrangement allows the user to acquire a book that is analogous to a book that has already been created.

An arrangement may be made in which, when the search server 50 receives a request from the terminal 10 for a search, the search server 50 stores the concept tree or book included in the search request.

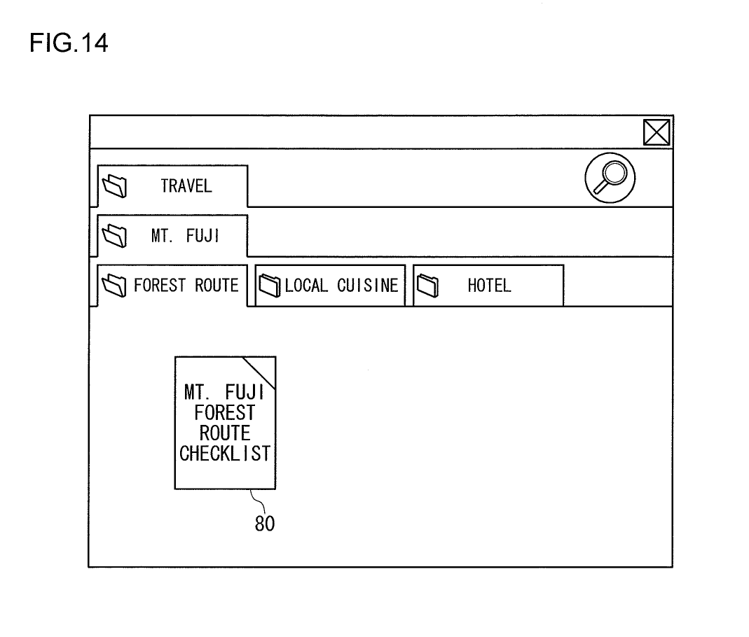

FIG. 14 shows an example of a screen displayed by the book display unit 26. On the screen, the keywords set for the respective nodes of the concept tree shown in FIG. 1 are displayed in the form of tabs. Such an arrangement allows the user to display the data classified under a desired node by selecting the tab that corresponds to the node to be displayed. In the example shown in FIG. 14, the “Mt. Fuji forest route checklist” document 80 classified under the “travel/Mt. Fuji/forest routes” node is displayed.

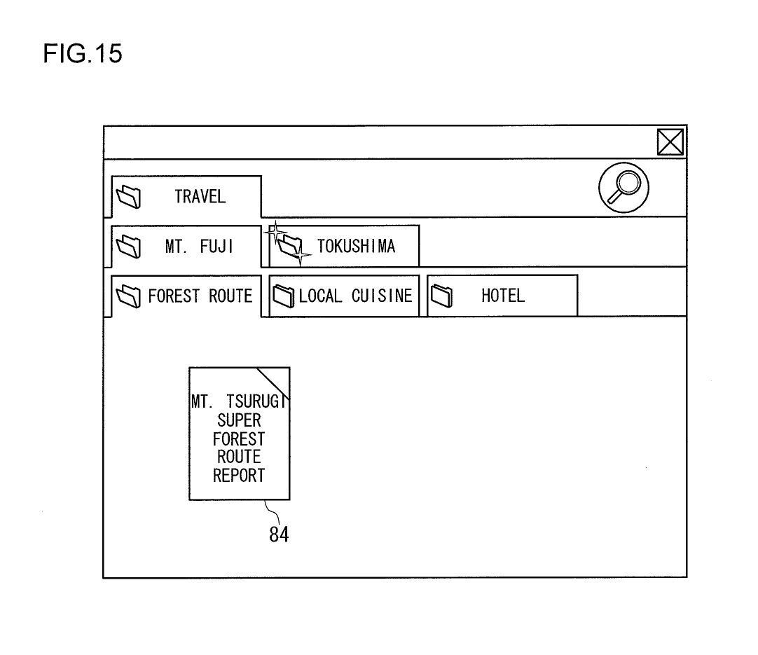

Such an arrangement allows the user to edit the concept tree via the screen shown in FIG. 14. For example, when the user inputs an editing instruction to add the “Tokushima” node as a sibling node of the “Mt. Fuji” node, the concept tree setting unit 22 adds the “Tokushima” node to the concept tree. In this case, the concept tree setting unit 22 may classify copies of the downstream nodes of the “Mt. Fuji” node as downstream nodes under the “Tokushima” node. FIG. 15 shows an example of the screen displayed by the book display unit 26 after the editing operation. In this case, the “Tokushima” tab is added at the same hierarchical level as that of the “Mt. Fuji” tab. The “Tokushima” tab icon is displayed in a special fashion that differs from other normal icons. This notifies the user that the “Tokushima” node has been newly added. The “Tokushima” node has a downstream node, i.e., a “forest routes” node for classifying information with respect to forest routes in Tokushima Prefecture, such as the “Mt. Tsurugi super forest route report” document 84 etc.

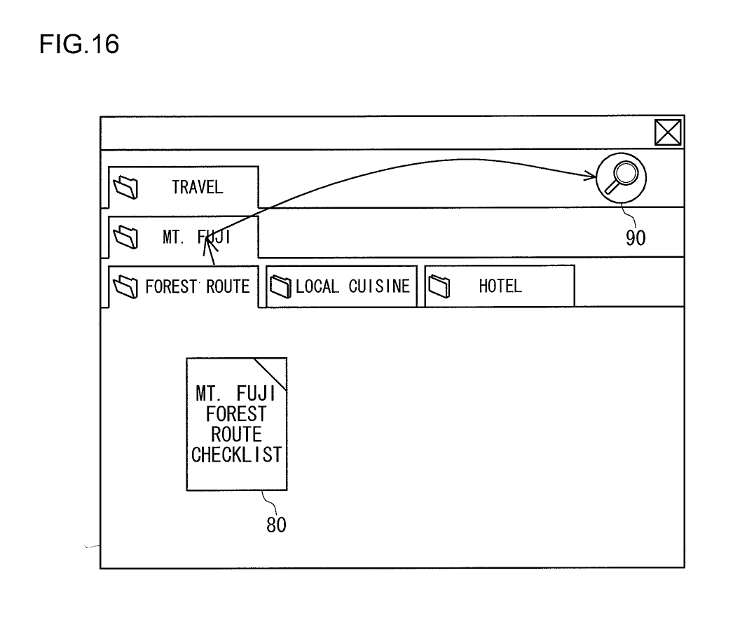

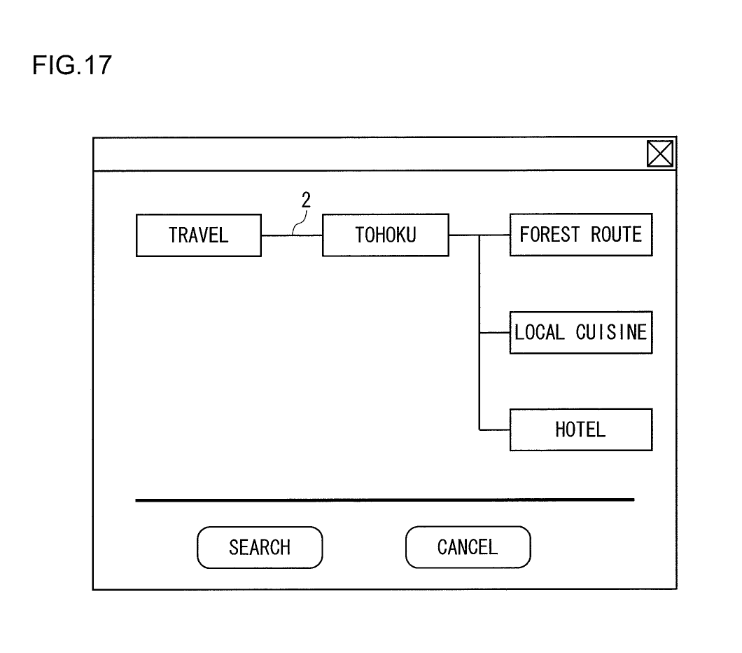

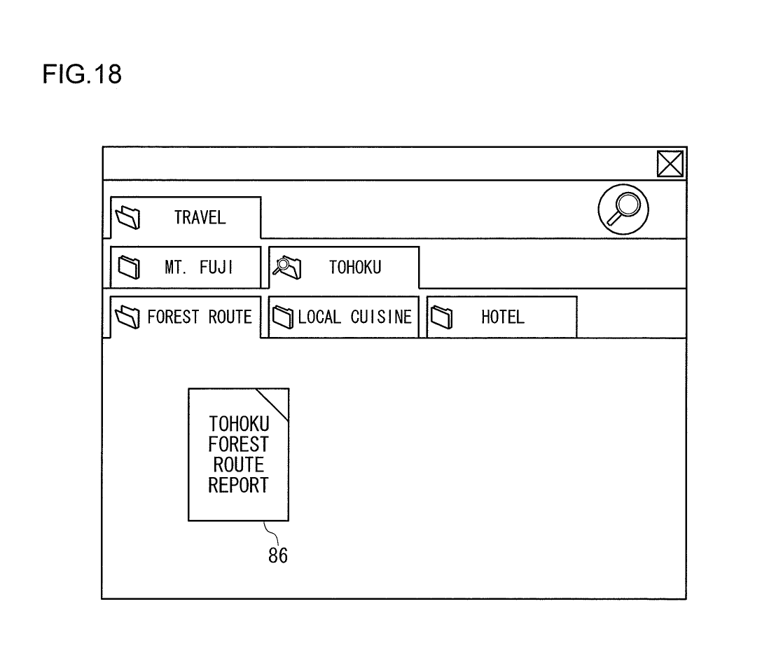

Such an arrangement allows the user to make a request via the screen shown in FIG. 14 for a search using a concept tree or the like as a query. For example, as shown in FIG. 16, when the user drags and drops the tab that represents the concept tree on a search icon 90 as shown in FIG. 16, the search request unit 28 displays a screen which allows the user to make a request for a search using the concept tree as a query. FIG. 17 shows an example of the search screen displayed by the search request unit 28. A concept tree 2 is displayed on the screen, which allows the user to edit the concept tree 2. For example, when the user makes a request for a search after switching the keyword from the “Mt. Fuji” node keyword set to the “Tohoku” node keyword set, the search request unit 28 makes a request to the search server 50 for a search using the concept tree 2 thus switched as a query. The search server 50 searches for or creates a book classified according to the concept tree 2 thus switched. The search result acquisition unit 32 acquires a book from the search server 50 as the search result. FIG. 18 shows an example of the display screen for a book thus extracted. For example, the information with respect to forest routes in the Tohoku region, such as the “Tohoku forest route report” document 86, is classified under the “travel/Tohoku/forest routes” node.

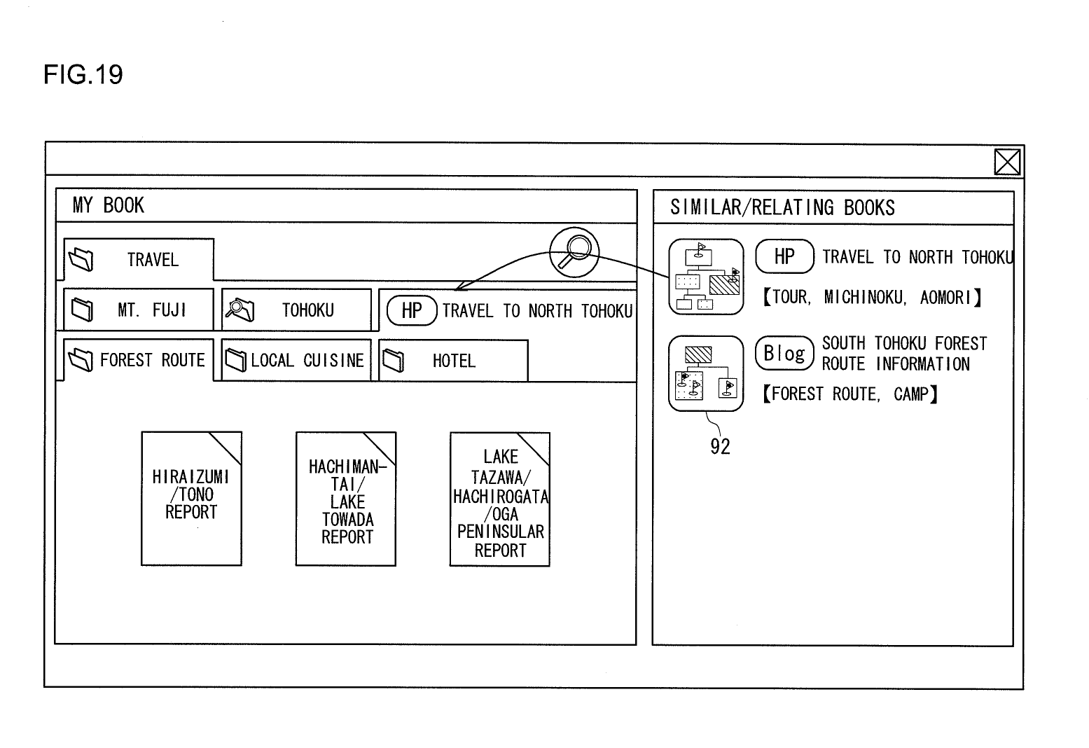

FIG. 19 shows an example of the screen for displaying the search results for the books extracted by the search server 50. On the right side of the screen, a list of the kinds of books, the titles, and the keywords are displayed as a result of a search made by the search server 50. Each book is represented by an icon 92 which displays a schematic structure of the corresponding book. Each node of the concept tree applied to the book is represented by a rectangular symbol, the size of which is determined based upon the amount of data included under the node, and the color of which is determined based upon the degree of similarity with respect to the concept tree or the book used as a reference for making the search. Furthermore, in a case in which the node has data in common with the book used as a reference for making the search, a flag is displayed at the symbol that represents the common data. In a case in which the common data has been updated recently, the circular flag mark is displayed as a solid black circle.

Via the screen shown in FIG. 19, such an arrangement allows the user to apply the user's own concept tree to a book obtained as the result of a search, and to display the book after the concept tree is applied. For example, when the user drags and drops the icon 92 that represents the book on the region on the left side of the screen where the user's own concept tree is displayed, the classification unit 24 reclassifies the data included in the book according to the concept tree thus displayed. For example, the “travel to North Tohoku” book includes various kinds of reports relating to the forest route information.

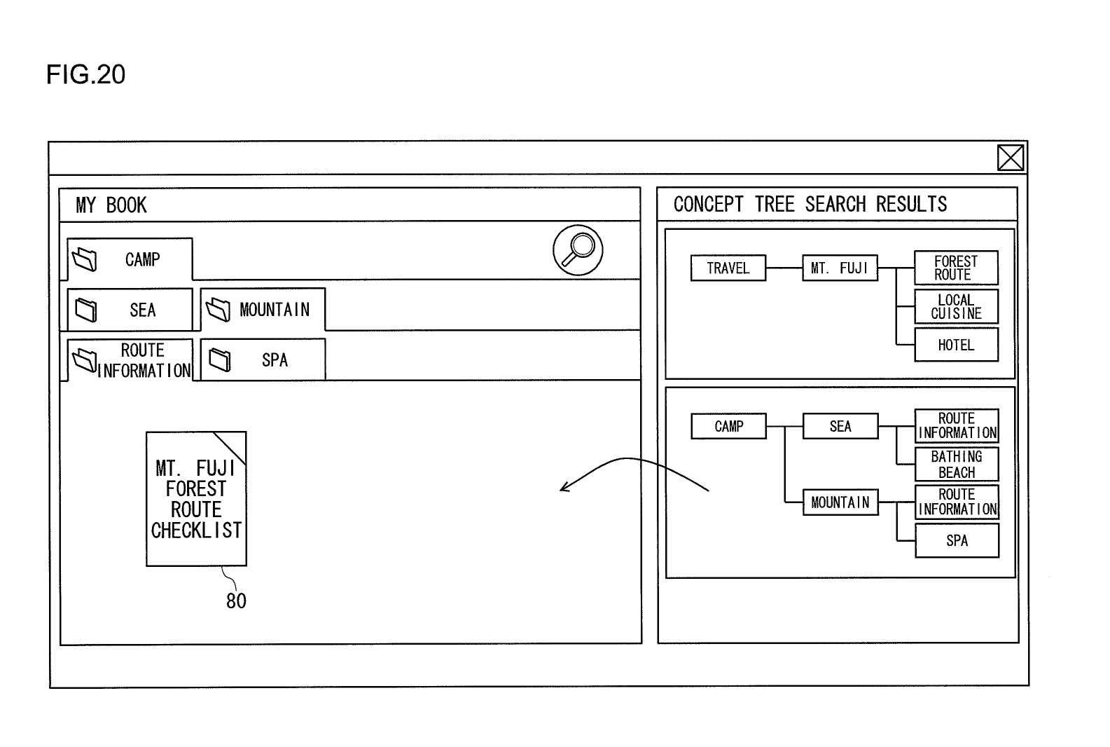

FIG. 20 shows an example of the screen for displaying the search results for the concept tree extracted by the search server 50. The right side of the screen displays the structure of the concept tree obtained as the result of a search made by the search server 50. Via the screen shown in FIG. 20, such an arrangement allows the user to apply the concept tree obtained as the result of the search to the user's own book, and to display the book after the concept tree is applied. For example, when the user drags and drops the concept tree on the region on the left side of the screen where the user's own book is displayed, the classification unit 24 reclassifies the data included in the book according to the concept tree. For example, the “Mt. Fuji forest route checklist” document 80 is classified under the “camp/mountain/route information” node.

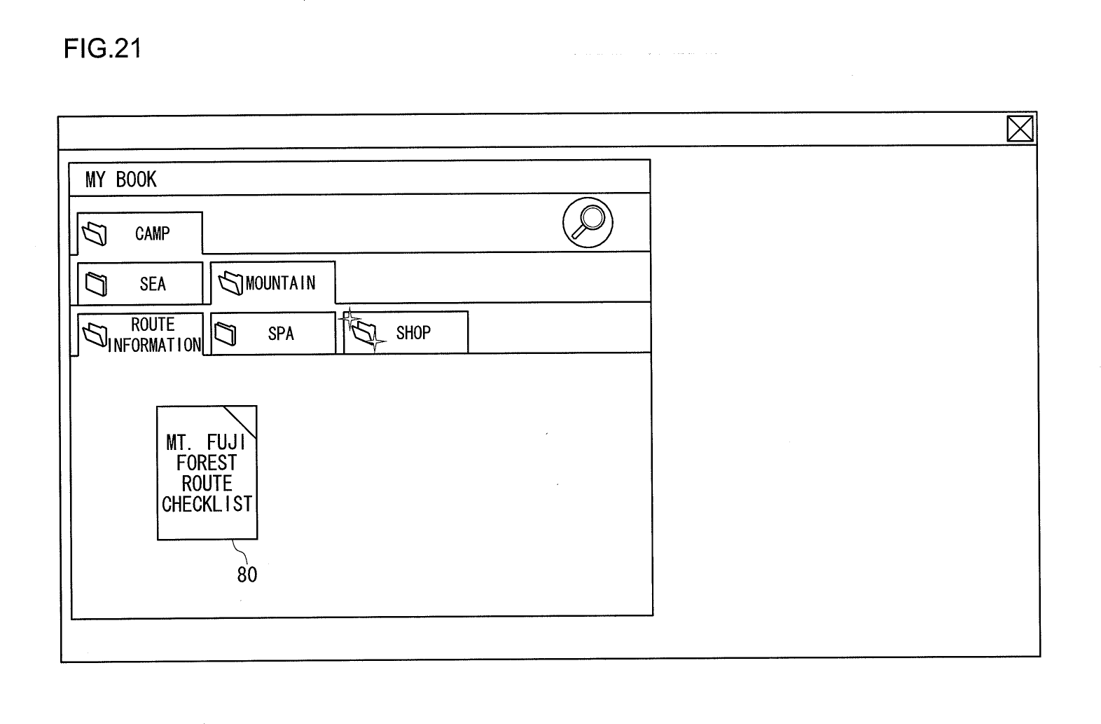

If the update unit 39 detects that a concept tree acquired from a different apparatus has been updated by the different apparatus, the update unit 39 displays, on the screen shown in FIG. 20, the updated part in a special fashion that can be clearly distinguished from the other part. FIG. 21 shows an example of the screen updated by the update unit 39. In the example shown in FIG. 21, the “shops” node has been added, which is represented by an icon displayed in a special fashion that differs from that of the other normal icons. Thus, such an arrangement notifies the user that the “shops” node has been newly added. In this case, the update unit 39 may search via the search server 50 for data to be classified under the “shops” node thus newly added, and may add the data thus extracted to the book.

When the book display unit 26 displays a book stored in the data storage unit 42, the search request unit 28 may automatically make a request to the search server 50 for a search for data, concept trees, or books relating to or analogous to the book thus displayed. For example, when the screen shown in FIG. 16 is displayed, the search request unit 28 may search via the search server 50 for a book relating to or analogous to the book or the concept tree thus displayed, and may display the search results using the UI as shown in FIG. 19. Also, the search request unit 28 may search via the search server 50 for a concept tree relating to or analogous to the book or the concept tree thus displayed, and may display the search results using the UI as shown in FIG. 20. Also, when the user selects the “forest routes” tab, for example, the search request unit 28 may automatically search, via the search server 50 based upon a keyword set of “travel”, “Mt. Fuji”, and “forest routes”, for the data to be classified under the “forest routes” tab, and may display the search results. Subsequently, when the user selects the “local cuisine” tab, the search request unit 28 may automatically search, via the search server 50 based upon the keyword set of “travel”, “Mt. Fuji”, and “local cuisine”, for the data to be classified under the “local cuisine” tab, and may automatically switch the display of the search results.

As described above, the technique according to the present embodiment allows a data set to be classified and displayed according to what the user values. Furthermore, such a technique allows the data set to be reclassified according to changes in the concept tree, thereby displaying the data according to changes in what the user values. Furthermore, such a technique provides a function for handling a situation in which the user desires to acquire a data set analogous to a book which has already been created and stored. That is to say, such a technique allows the user to edit the concept tree as appropriate, thereby allowing the user to search for and classify data in a simple manner.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

What is claimed is:

1. A data processing apparatus comprising:
a concept information setting unit which sets concept information that indicates a user's purposes or intentions;
a storage unit which stores a data set created or acquired by the user;
a classification unit which classifies the data set based upon the concept information; and
a display unit which displays the data set thus classified.

2. A data processing apparatus according to claim 1, wherein said concept information setting unit sets, as the concept information, a hierarchical tree by classifying a plurality of keywords that indicate the user's purposes or intentions,
and wherein said classification unit calculates a degree of similarity between each item of data included in the data set and the keywords,
and wherein the data that exhibits a higher degree of similarity with a given keyword than a predetermined value is classified under a node that corresponds to the given keyword, thereby classifying the data set in a hierarchical manner.

3. A data processing apparatus according to claim 2, further comprising an acquisition unit which acquires from a different apparatus a data set classified based upon concept information,
wherein said classification unit classifies the data set thus acquired by the acquisition unit based upon the concept information set by said concept information setting unit.

4. A data processing apparatus according to claim 3, further comprising an update unit in which, when said update unit detects that the data set acquired by said acquisition unit has been updated by the different apparatus, the update unit instructs said acquisition unit to acquire the data set thus updated by the different apparatus,
and wherein said classification unit classifies the updated data set based upon the concept information.

5. A data processing apparatus according to claim 2, further comprising an acquisition unit which acquires the concept information from a different apparatus,
wherein said classification unit classifies the data set stored in said storage unit based upon the concept information acquired by said acquisition unit.

6. A data processing apparatus according to claim 5, further comprising an update unit in which, when said update unit detects that the concept information acquired by said acquisition unit has been updated by the different apparatus, the update unit instructs said acquisition unit to acquire the concept information thus updated by the different apparatus,
and wherein said classification unit classifies the data set stored in said storage unit based upon the concept information thus updated.

7. A data processing apparatus according to claim 2, further comprising a search request unit which makes a request for a search for the concept information or the data set using the keywords, the concept information, or the data set as a query; and
a search result acquisition unit which acquires the concept information or the data set as a result of the search.

8. A data processing method for instructing a computer to execute processing, wherein said processing comprises:
setting a hierarchical tree by classifying a plurality of keywords that indicate a user's purposes or intentions;
calculating a degree of similarity between each item of data included in a data set created by or acquired by the user and the keywords, and classifying the data that exhibits a higher degree of similarity with respect to a given keyword than a predetermined value under a node that corresponds to the given keyword, thereby classifying the data set in a hierarchical manner; and
displaying the data set thus classified.

9. A computer program product comprising:
a module which sets a hierarchical tree by classifying a plurality of keywords that indicate a user's purposes or intentions;
a module which calculates a degree of similarity between each item of data included in a data set created by or acquired by the user and the keywords, and which classifies the data that exhibits a higher degree of similarity with respect to a given keyword than a predetermined value under a node that corresponds to the given keyword, thereby classifying the data set in a hierarchical manner; and
a module which displays the data set thus classified.

10. A search apparatus comprising:
a search request reception unit which receives a search request with concept information, including a hierarchical tree created by classifying a plurality of keywords that represent a user's purposes or intentions, as a query;
a creation unit which searches for data based upon each keyword included in the concept information, and which classifies the data that exhibits a higher degree of similarity with respect to a given keyword than a predetermined value under a node that corresponds to the given keyword, thereby creating a data set classified in a hierarchical manner based upon the concept information; and
a search result transmission unit which transmits the data set thus created as the search results.

11. A search apparatus comprising:
a search request reception unit which receives a search request with concept information, including a hierarchical tree created by classifying keywords that represent a user's purposes or intentions, a data set classified in a hierarchical manner based upon the concept information, or the keywords, as a query;
a search unit which searches for concept information or data sets analogous to the concept information, the data set, or the keywords thus received; and
a search result transmission unit which transmits the concept information or the data set thus extracted as the search results.
